(19) United States
(12) Patent Application Publication
(10) Pub. No.: US 2010/0129505 A1
(43) Pub. Date: May 27, 2010

(54) DYED AND FLAVORED GELS FOR CO-EXTRUSION

(76) Inventors: George Hayes, West Columbia, SC (US); Marco Hobi, West Columbia, SC (US); Ken Stribling, Geneva, IL (US)

Correspondence Address: NEXSEN PRUET, LLC, P.O. BOX 10648, GREENVILLE, SC, 29603, US

(21) Appl. No.: 12/606,668

(22) Filed: Oct. 27, 2009

Related U.S. Application Data
(63) Continuation-in-part of application No. 11/842,348, filed on Aug. 21, 2007.

(51) Int. Cl. A23L 1/0562; A23L 1/275

(52) U.S. Cl. 426/250; 426/576

(57) ABSTRACT

A composition of an edible collagen and a method of its preparation useful for manufacturing edible enclosures or casings for food products that possess a desired color and flavor profile, such as deemed useful for cheese or sausage casings.

### CROSS REFERENCE TO RELATED PATENTS

The present invention claims the benefit of priority of U.S. Nonprovisional application Ser. No. 11/842,348, filed Aug. 21, 2007, the entire contents of which is incorporated herein by reference.

### BACKGROUND OF THE INVENTION

This invention relates to edible food casings, especially for cheese or sausage casings, and more particularly to a method of preparing a stable dyed and/or flavored collagen composition or gel that may be sold to casing or sausage manufacturers whom in turn use the dyed, flavored or both, collagen gel to produce collagen casings possessing a predetermined color and flavor profile.

Traditionally, manufacturers of collagen encased products, such as sausages, made products in the casing's natural white color or obtained a more commercially appealing color and flavor by proper selection of the meat block, imparting color and flavor during the cooking process, imparting color in the casing after extrusion, utilized an encapsulating agent to encase the dyestuff for admixing with the casing material, or utilizing cocoa based dyestuff for admixing with the collagen gel. Manufacturers have produced collagen encased products using a co-extrusion method, or an older method of extruding the food product into a prepared casing.

The co-extruding systems are typically high production rate systems that extrude a collagen film (tubular casing) along with the meat into a coagulation bath or baths. The manufacturer then links or hangs this sausage rope before feeding it into a cooking system usually designed specifically for this type of production. Until this invention, these co-extrusion machines used naturally colored (white) collagen gels to encase the sausage. A variety of different product types and flavors are produced using this equipment. However, for a number of these products it is desirable to impart a specific color and/or flavor profile to the final product that will improve the product's commercial appeal. Depending on the product type, the desirable colors include but are not limited to yellow, brown, red and white. Desirable flavors, especially in the packaged meat industry, include but are not limited to capsicum, jalapeno, paprika, cheddar, southwestern, smoked, and maple syrup.

Historically, manufacturers obtained such colors and flavors either by proper selection of the meat block or by the cooking process. Unfortunately, the cost and/or availability of the meat in the first case and capabilities of the cooking process in the second, limit the ability to impart color and flavor in the finished product. With respect to the yellow/red/brown color typically imparted by the smoking process, a producer wishing to increase its desired color intensity must either run more smoke generators, which are expensive and raise significant regulatory issues, or slow down his process. Neither of these alternatives is economically desirable.

In addition imparting color and flavor in the cooking phase of production, non-co-extruded products typically achieve a desired color and flavor profile by imparting color and flavor into the collagen casing by washing the casing in a dye solution prior to filling, spraying, or overcoating the food product such as described in U.S. Pat. Nos. 4,038,438; 3,961,085; and 3,539,361 respectively. These methods require an additional step post extrusion, and are limited to use with non-co-extruding production methods.

Another method of incorporating the dye includes admixing the dyestuff prior to casing extrusion. U.S. Pat. No. 4,061,786 describes a dyed edible food casing produced by admixing dye previously fixed to an edible carrier prior to extrusion. The fixing of the dye to an edible carrier prior to admixing creates additional steps of dye preparation. U.S. Pat. No. 4,728,523 describes another example of a dyed edible food casing produced by admixing dye prior to extrusion; dyed food casing utilizing a water-insoluble dye composed of chocolate liquefied in vegetable oil; whereas the present invention discloses the process of producing an edible collagen composition colored with a water soluble dye.

### BRIEF SUMMARY OF THE INVENTION

The following presents a simplified summary of the invention in order to provide a basic understanding of some aspects of the invention. This summary is not an extensive overview of the invention. It is not intended to identify key or critical elements of the invention or to delineate the scope of the invention; its sole purpose is to present concepts of the invention in a simplified form as a prelude to the more detailed description that is subsequently presented.

The introduction of a variety of natural and/or food approved artificial colorings and flavor additives into the otherwise white, tasteless collagen gel allows the food manufacturer, such as a sausage manufacture, to specify an exact color and flavor profile without the need to run more smoke generators or to slow down the process. Disclosed and claimed herein is an innovative process for the preparation of pre-dyed collagen gel product to be used in the production of a colored and/or flavored edible collagen casing. In addition, this invention produces a new collagen gel product that may be custom dyed and flavored with a predetermined color and flavor profile and can be sold to the food product producer designed to meet the producer's color and flavor requirement. Dyed and flavored collagen casings produced using the process herein disclosed possess greater resistance to color and taste fade due to storage or light exposure than collagen casings dyed and flavored using other methods.

Depending on the desired color and flavor profile, the present invention contemplates the use of color additives in combination with flavor additives to impart both color and flavor, respectively, into a food casing gel. Alternatively, certain flavor additives that also include color properties can be used to impart both color and taste to the food casing gel. Additionally, certain flavor additives that exhibit no color properties can be used to produce a clear, yet flavored food casing gel.

Other features and their advantages will be readily apparent to those skilled in edible food casings, techniques and equipment from a careful reading of the Detailed Description of Preferred Embodiments, accompanied by the following drawings.

### BRIEF DESCRIPTION OF THE DRAWINGS

FIG. 1 graphically depicts the flavor profile of cooked sausage blind test results.

FIG. 2 graphically depicts the color profile of cooked sausage blind test results.

FIG. 3 is a flowchart of the steps of the process disclosed herein for producing dyed and flavored gels for co-extrusion.

### DETAILED DESCRIPTION OF THE INVENTION

In accordance with this invention, it has been found that the collagen casing precursor may be dyed to a desirable color and/or flavored to a desirable taste and co-extruded with the food product to have the desired color and taste in the final product.

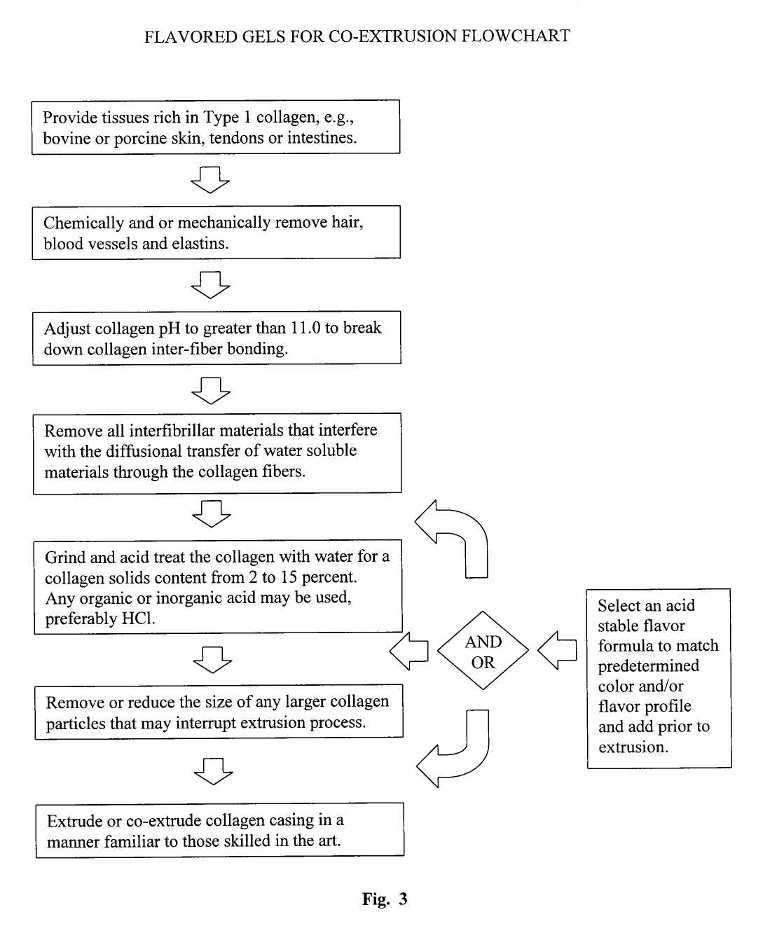

The collagen casings produced using the process of the present invention are usually, but not necessarily, produced using an extrusion method as shown in the flow chart of FIG. 3. Such casings are usually, but not necessarily, tubular and may be co-extruded to encase an edible food product or extruded alone to form an empty casing for filling at a later time. Such collagen gel can be used in the production of a group of collagen encased products including sausages and cheeses. The novel process of this invention includes: 1) Procuring collagen from any source known to those skilled in the art, e.g., from bovine or porcine collagen harvested from a part of the animal rich in Type 1 collagen, such as the skin, tendons or intestines. 2) Chemically or mechanically removing hair, blood vessels, and elastins from the tissue. 3) Adjusting the collagen pH to greater than 11.0 to break down the collagen inter-fiber bonding. 4) Removing all interfibrillar materials that interfere with the diffusional transfer of water soluble materials through the collagen fibers. Failure to properly remove these materials will detrimentally impact the ability to add dyes.

The next step is to 5) grind and acid swell the collagen with water. Any of a number or combination of organic and inorganic acids may be used, but HCL is preferred. The collagen solids content at this point may vary from 2 to 15 percent by weight. Following this step is the step of 6) eliminating the larger collagen particles, as these tend to interrupt the extrusion process. Elimination of the larger particles may be achieved by reduction through further grinding or by removal through filtering. The next steps are to: 7) select an acid stable dye formula to match the final product appearance criteria; and/or 8) select a natural or artificial, food approved, acid stable flavor formula to match the final product taste criteria.

The acid stable dye formula would include, but not be limited to, annatto, carmine, and/or caramel. Water soluble forms of dye are added at a volume and dye concentration to achieve the desired final product color and percent solids. The acid stable flavor formula would include, but not be limited to, capsicum (natural flavor), jalapeno (natural flavor), paprika (natural oleoresin flavor), cheddar (artificial flavor), and/or southwestern (artificial flavor). Water soluble forms of flavor additives are added at a volume and concentration to achieve only the desired final product flavor, both the desired product flavor and color, or only the desired product color, as well as percent solids.

The gel form of the product then may be sold and transported to a casing or sausage manufacturing facility where the gel is extruded to form a collagen casing. The casing then may be hardened, tanned and filled or co-extruded with an edible food product and otherwise processed in a manner familiar to those skilled in the art.

This invention is further illustrated by the following example. It should not be construed, however, that the invention is limited in this specific example.

A clear, standard coextrusion gel was provided to make a control bratwurst type sausage product.

A first batch of collagen gel was produced from a flavored gel (“flavored product”) containing natural paprika flavor, which is a water soluble, acid-stable flavor, added to achieve a stuffed collagen food casing possessing a predetermined color profile, nearly identical to that of the control bratwurst type sausage. The flavored gel produced a final sausage that did not exhibit any flavor enhancement when compared to the same sausage extruded with standard, clear coextrusion gel. However, the paprika flavor added did impart an orange color to the final sausage product.

A second batch of collagen gel was produced from a flavored product containing both natural paprika flavor and artificial cheddar flavor. The resulting gel was orange in color, and also exhibited a strong cheese odor, as compared to the control gel. This gel product was extruded to make the same bratwurst sausage as the first batch and the control gel. The final product of the second batch exhibited a slight cheese odor. The taste of the sausage of the second batch was not dominated by cheese taste, although the taste was different than the control sausage and the sausage made from the first gel batch.

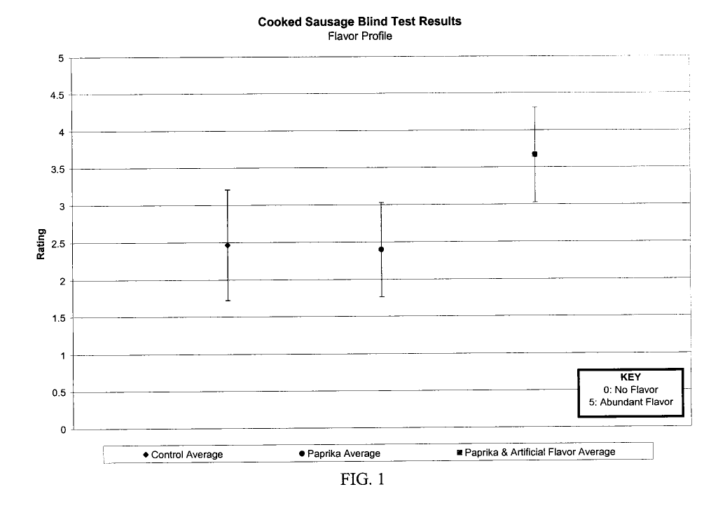

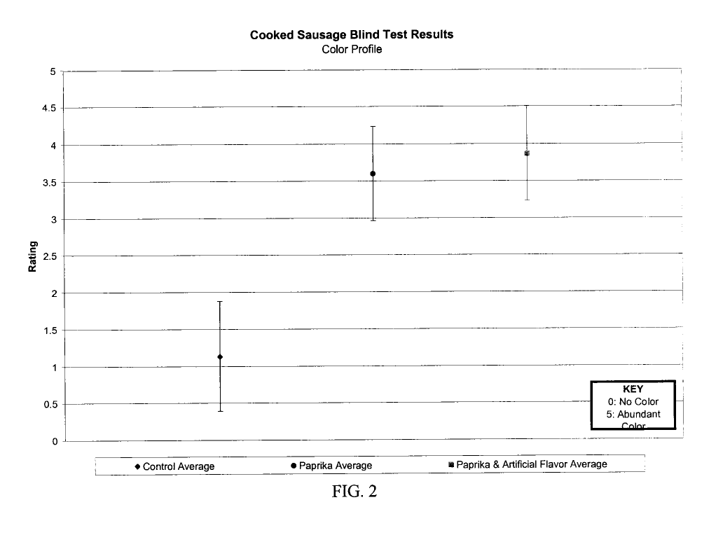

Each of the final sausage products was subjected to a blind taste test. The results from this test are presented in the graphs provided in FIGS. 1 and 2 below. Overwhelmingly, a taste difference was noted between the sausage made from the second batch compared to the sausages made from the first batch and the control gels. However, the taste difference was not necessarily based on cheese flavor. In particular, the blind test results were performed against two test criteria—flavor and color. Both criteria were analyzed using a 0-5 rating scale, although the criteria were rated separately. The attached graphs contain the data for this analysis. The first graph depicts the blind flavor test, while the second graph depicts the color test. By analysis of both graphs, it was concluded that value was added by either of the flavor gels, as there was an increased liking of color using either of the flavor enhanced gels, and an increased liking of flavor using the Paprika & Artificial Flavor gel.

Having generally described the invention and provided specific examples, variations will become apparent to those of skill in the art. Such variations, however, are intended to be with the spirit and scope of this invention as defined by the following appended claims.

1. A process for the manufacture of a collagen gel to be used in the production of an edible collagen casing, comprising the steps of:
providing a collagen material,
removing interfibrillar materials from said collagen material,
grinding said collagen material to a particle size suitable for dissolution,
acid treating said ground collagen material,
eliminating collagen particles that are sufficiently large to interrupt the extrusion process and,
adding a water soluble acid stable flavor to said collagen material.

2. The process of claim 1 in which the source of said collagen material is bovine tissue.

3. The process of claim 1 in which the source of said collagen material is porcine tissue.

4. The process of claim 1 in which said collagen material is rich in Type 1 collagen.

5. The process of claim 1 in which the source of said collagen material is tissue rich in Type 1 collagen selected from a group of tissues including skin, tendons, and intestines.

6. The process of claim 1 in which said acid treatment uses an inorganic acid.

7. The process of claim 1 in which said acid treatment uses an organic acid.

8. The process of claim 1 in which said acid treatment uses a mixture of inorganic and organic acids.

9. The process of claim 1 in which said acid treatment uses HCl.

10. The process of claim 1 in which said ground collagen material after said acid treatment has collagen solids content in the range of 2 to 15 percent by weight.

11. The process of claim 1 in which the collagen particles eliminated to prevent interruption to the extrusion process are eliminated by removal.

12. The process of claim 1 in which the collagen particles eliminated to prevent interruption to the extrusion process are eliminated by reduction.

13. The process of claim 1 in which said flavor is added to the collagen at a volume and concentration to achieve the desired final product color and percent solids.

14. The process of claim 1 in which said flavor is added to the collagen at a volume and concentration to achieve the desired final product flavor and percent solids.

15. The process of claim 1 in which said flavor is added to the collagen at a volume and concentration to achieve the desired final product flavor and color and percent solids.

16. The process of claim 1, further comprising the step of adding a water soluble acid stable color to said collagen material.

17. The process of claim 16 in which said flavor is added to the collagen at a volume and concentration to achieve the desired final product flavor and percent solids, and in which said color is added to the collagen at a volume and concentration to achieve the desired final product color and percent solids.

18. The process of claim 16 in which said dye is selected from a group of coloring agents including FD&C dyes, annatto, carmine, and caramel.

19. The process of claim 16 in which said dye is added during or after said step of grinding and said acid treatment of the collagen.

20. The process of claim 1 in which said flavor is selected from a group including paprika, capsicum, jalapeno, cheddar, and southwestern.

21. A collagen gel to be used in the production of an edible collagen casing, comprising of a collagen composition with reduced interfibrillar materials and an edible water soluble acid stable flavor.

22. The gel of claim 21 containing one or more flavor additives selected from the group including capsicum, jalapeno, paprika, cheddar and southwestern.
